(19) United States
(12) Patent Application Publication
(10) Pub. No.: US 2009/0240347 A1
(43) Pub. Date: Sep. 24, 2009

(54) OPERATING METHOD FOR A CONTROL DEVICE OF A SAFETY-ORIENTED AUTOMATION DEVICE FOR CHECKING THE RELIABILITY OF AN AUTOMATION SYSTEM

(75) Inventors: Hanno WALDERS, Erlangen (DE); Ulrich HAHN, Neustadt (DE); Gunter SCHWESIG, Erlangen (DE); Dietmar WANNER, Herzogenaurach (DE)

Correspondence Address: Henry M. Feiereisen;Henry M. Feiereisen, LLC, Suite 4714, 708 Third Avenue, New York, NY, 10017, US

(73) Assignee: Siemens Aktiengesellschaft, Munchen (DE)

(21) Appl. No.: 12/196,634

(22) Filed: Aug. 22, 2008

(30) Foreign Application Priority Data
Aug. 22, 2007 (EP) 07016485

(51) Int. Cl. G05B 19/18

(52) U.S. Cl. 700/9

(57) ABSTRACT

Information describing an automation system is input into a control device of an automation device. The information the information includes a description of elements of the automation device, a description of interaction between the elements, and safety-related reliability information associated with the elements. The control device independently determines from the provided information reliability information for the automation device as a whole.

### CROSS-REFERENCES TO RELATED APPLICATIONS

This application claims the priority of European Patent Application, Serial No. 07016485, filed Aug. 22, 2007, pursuant to 35 U.S.C. 119(a)-(d), the content of which is incorporated herein by reference in its entirety as if fully set forth herein.

### BACKGROUND OF THE INVENTION

The present invention relates to an operating method for a control device of an automation device, wherein at least the safety and/or reliability of the control device has already been verified.

Automation devices and automation systems are generally known. They are used for controlling technical processes and installations in many areas. Examples of automation devices and automation systems are CNC (computerized numerical control) controllers, MC (motion control) controllers and SPS (stored-program control) controller, with peripheral elements.

In many cases, the automation devices and systems carry out safety-oriented functions. In such cases, the corresponding devices and systems must be safe.

Verification of the functional safety of such devices and systems requires the calculation of the hazard rate (for example according to IEC 61508-6 Appendix B). The basis for the calculations are modelings with respect to the functional safety and the calculation of these modelings via iterative methods, linear approximations or—in the case of very simple modelings—by closed solutions.

In complex devices or systems which can be operated in various configurations, it is possible to specify not only a single numerical value as hazard rate. Instead, the hazard rate must be determined separately for each configuration. In this context, the expenditure and also the possible breadth of the (correct) hazard rates increase greatly with the multiplicity of components and their possible combinations.

The values determined are part of a safety system. Thus, they are also a component of the certification documents which are presented at a corresponding licensed certification institute for certifying these devices or systems.

In the prior art, the hazard rate is calculated by an expert. As a rule, this is the same person who also creates other parts of the documents required for the certification. The hazard rate determined by the expert is checked by the certification office. In this process, the basic models and their approaches (equations or algorithms) are checked, among other things.

In the prior art, complex systems require a simplification in order to keep the mathematical complexity within a reasonable frame. The simplification consists in that a number of configurations are combined and the most hazardous of these is considered. For the reduced number of possible configurations, corresponding hazard values are specified in table form so that the user can select a configuration which meets his safety requirements. In many cases, this leads to the automation system or the automation device which is used for a certain automation task being safer than would be required for the automation task.

The hazard rate to be determined is a safety-related parameter. For this reason, the algorithms, numerical values etc. forming the basis of the determination of the hazard rate are also in turn safety-related. The use of general calculation tools (mathematics programs, table calculation etc.) is therefore critical since such software tools and the associated hardware platforms must be subjected to safety-related requirements which can either not be met or can only be met with extremely inconvenient modifications for the customer.

It would therefore be desirable and advantageous to provide possibilities for being able to provide in a simple manner, with quantitative reliability, information about the reliability of an automation system to be assessed.

### SUMMARY OF THE INVENTION

According to one aspect of the present invention, a method for operating a control device of a safety-oriented automation device includes providing to the control device information which describes an automation system, wherein the information includes a description of elements of the automation device, a description of interaction between the elements, and safety-related reliability information associated with the elements. The method then determines with the control device from the provided information reliability information for the automation device as a whole.

To input the information describing the automation system, various procedures are possible which can be combined with one another arbitrarily and as required. Thus, it is possible, for example, that the control device reads the information at least partially out of an internal memory of the control device. Similarly, the information can be input into the control device at least partially by a user of the control device. It is also possible to input the information into the control device at least partially via a computer network link. If the automation system is identical with the automation device, it is also possible that the control device determines the information at least partially independently.

It is possible that the control device further processes the determined reliability information internally for the automation system as a whole or outputs it to another device (for example a computer networked with the control device). Preferably, however, the control device outputs the reliability information, determined by it, about the automation system as a whole to a user of the control device.

The control device preferably determines over at least two channels independently of one another in each case one reliability information item for the automation system as a whole. In this case, the control device compares with one another the reliability information determined over at least two channels for the automation system as a whole and outputs the result of the comparison as such to the user of the control device.

The determination over at least two channels can take place, for example, by the processing of diversified software. As an alternative or additionally, the control device can have at least two sub-control devices. In this case, each of the sub-control devices can determine the respective reliability information for the automation system as a whole independently of the in each case other sub-control devices. In the last-mentioned case, the sub-control devices can be constructed, in particular, to be diversified.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows by way of example the structure of an automation device,

FIGS. 2 and 3 show flow charts and

FIG. 4 shows a possible structure of a control device.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

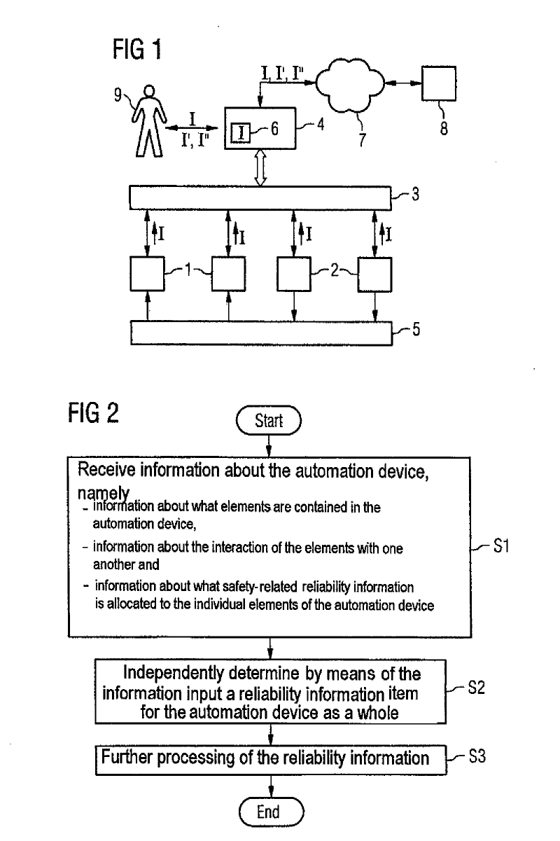

Turning now to the drawing, and in particular to FIG. 1, there is shown an automation device having various elements 1 to 4. Purely by way of example, FIG. 1 shows two input elements 1, two output elements 2, one distributor element 3 and one control device 4. However, depending on requirements, the automation device could have other and/or more or fewer elements 1 to 4, particularly considerably more elements 1 to 4.

By means of the automation device, it is intended to monitor and control, among other things, safety-oriented functions of a technical process 5. It is of significance, therefore, that the automation device meets reliability conditions. In this context, the reliability conditions are regulated by relevant standards. They can depend on the type of the technical process 5 and the type of the safety-oriented functions.

To check whether the automation device as a whole meets the required reliability conditions, the control device 4 of the automation device carries out a method which will be explained in greater detail in conjunction with FIG. 2 in the text which follows.

According to FIG. 2, information I which describes the automation device is input into the control device in a step S1. In this context, the information I comprises what elements 1 to 4 are contained in the automation device. Furthermore, the information I comprises how the elements 1 to 4 of the automation device interact, particularly the topology of the elements 1 to 4. Furthermore, the information I comprises what safety-related reliability information is allocated to the individual elements 1 to 4 of the automation device.

The information I can be input as required. For example, the information I can be stored in an internal memory 6 of the control device 4 according to FIG. 1. In this case, the control device 4 reads the information I out of the internal memory 6. Similarly, it is possible that the information I is input into the control device 4 via a computer network link 7 (for example the Internet or a LAN) by a computer 8. It is also possible that the information I is input into the control device 4 by a user 9 of the control device 4. Finally, it is possible that the control device 4 determines the information I independently. For example, the control device 4 can automatically determine the configuration of the automation device at the initial start-up, read the information about the respective element 1 to 4 in each case out of the individual elements 1 to 4 and thus obtain the information I about the automation device.

Furthermore, arbitrary mixed forms of the abovementioned procedures are possible. For example, the control device 4 can first carry out the attempt of determining the information I itself as described last, then ask the user 9 whether the information I is complete and then (if required) receive a completion of the information I. It is also possible that the information I is input into the control device 4 redundantly in at least two different ways, for example, on the one hand, by self-determination and, on the other hand, via the computer network link 7. In this case, it is possible to check the information I for correctness and consistency.

In a step S2, the control device 4 independently determines by means of the information I input a reliability information item I′ for the automation device as a whole. For example, it determines a code number which specifies how large the hazard rate according to IEC 61508-6 Appendix B is. However, as an alternative or additionally, other values can also be determined.

The reliability information I′ determined for the automation device as a whole is processed further by the control device 4 in a step S3. For example, the control device 4 can output the reliability information I′ to the user 9 as part of step S3.

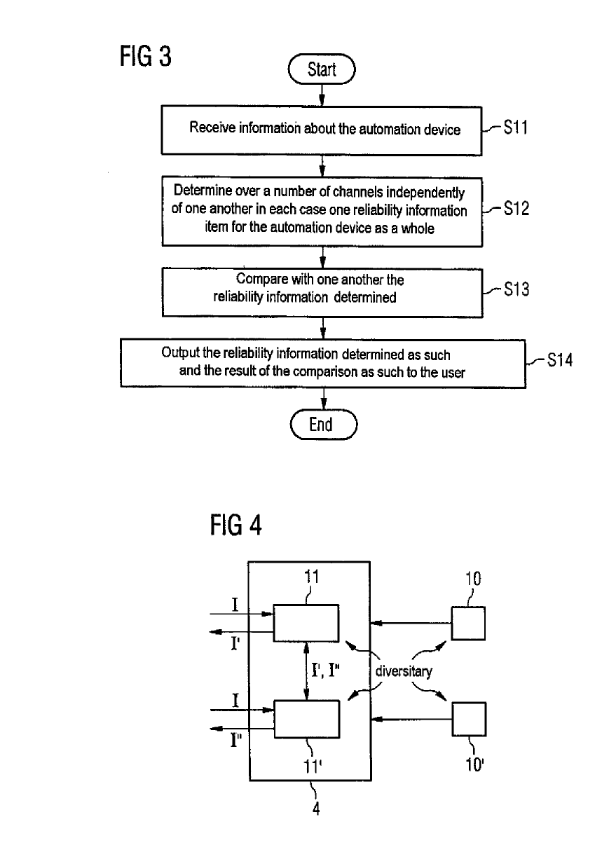

In many cases, the control device 4 determines over at least two channels independently of one another in each case one reliability information item I′, I″. If this is the case, the procedure of FIG. 2 is modified as will be explained in greater detail in conjunction with FIG. 3 in the text which follows.

According to FIG. 3, the information I is input into the control device 4 in a step S11. Step S11 corresponds to step S1 of FIG. 2.

In a step S12, the control device 4 determines over several channels independently of one another in each case one reliability information item I′, I″ for the automation device as a whole. Step S12 essentially corresponds to a multiple, mutually-independent execution of step S2.

In a step S13, the control device 4 compares with one another the reliability information I′, I″ determined by it. In a step S14, the control device 4 outputs, on the one hand, the reliability information I′, I″ as such, determined by it, and, on the other hand, the result of the comparison as such to the user 9.

For determining the reliability information I′, I″ over at least two channels, it is possible that the control device 4 processes diversified software 10, 10′ according to FIG. 4. In this context, the control device 4 determines in each case once per unit of the diversified software 10, 10′ one of the reliability information items I′, I″. Furthermore, it receives the results of the other determinations per unit and carries out the abovementioned comparison.

According to FIG. 4, it is possible that the control device 4 is constructed as a uniform control device 4 which processes the individual units of the diversified software 10, 10′. Preferably, however, the control device 4 has at least two sub-control devices 11, 11′. In this case, each of the sub-control devices 11, 11′ determines a respective reliability information item I′, I″ for the automation device as a whole independently of the in each case other sub-control devices 11′, 11. The software units utilized for determining the individual reliability information I′, I″ can be, as an alternative, diversified or non-diversified.

According to FIG. 4, the sub-control devices 11, 11′ are constructed to be diversified. However, this is not mandatorily required. As an alternative, the sub-control devices 11, 11′ could be constructed to be identical to one another.

In the above text, the case was explained that reliability information I′, I″ of the automation device was determined, that is to say exactly of the automation system, the component of which is the control device 4. However, this is not mandatorily required. The control device 4 could also determine the reliability information I′, I″ for an automation system which differs from the automation device. In this context, the only relevant difference from the procedures explained above consists in that, in this case, the control device 4 cannot independently determine the information I which describes the automation system.

The software for determining the reliability information I′, I″ can be a component of the normal operating software of the control device 4, that is to say of the software which is used for implementing the actual control task. As an alternative, it can be a separate software.

In addition to the determination of the reliability information I′, I″ by the control device 4, a further reliability information item can be determined by means of another hardware and software, before or afterwards in time. The further hardware and software can be designed, for example, to be PC-based. The safety and/or reliability of the further hardware and software must be verified, if necessary, in this case.

If there are several individual results for the reliability information I′, I″ in the context of the present invention, the results can be compared automatically. As an alternative, it is possible to output the individual results to the user 9 so that he can perform the comparison.

The present invention has many advantages. In particular, it is no longer required, for example, to combine a number of configurations or to perform linearization. This results in an exact numerical value for each configuration, for example for the hazard rate. This advantage can have a significant effect particularly in the case of complex systems. In addition, the calculation of the reliability information I, I′ for the automation device, the component of which is the control device 4, offers the possibility of independently determining the relevant information I which describes the automation system. Furthermore, the amount of documentation is reduced for the customer.

The above description is exclusively used for explaining the present invention. On the other hand, the protective range of the present invention should be determined exclusively by the attached claims.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for operating a control device of a safety-oriented automation device, comprising the steps of:
providing to the control device information which describes an automation system, wherein the information includes a description of elements of the automation device, a description of interaction between the elements, and safety-related reliability information associated with the elements, and
determining with the control device from the provided information reliability information for the automation device as a whole.

2. The method of claim 1, wherein the information which describes the automation device is stored in a memory of the control device.

3. The method of claim 1, wherein at least a part of the information which describes the automation device is provided to the control device by a user.

4. The method of claim 1, wherein at least a part of the information which describes the automation device is provided to the control device via a computer network link.

5. The method of claim 1, wherein the automation device is identical to the automation system, and wherein the control device determines the information which describes the automation system at least partially independently.

6. The method of claim 1, wherein the control device outputs the determined reliability information to a user of the control device.

7. The method of claim 1, wherein the control device determines the reliability information over at least two independent channels, compares the reliability information from the at least two channels with one another, and outputs the result of the comparison to a user of the control device.

8. The method of claim 7, wherein the at least two channels execute diversified software.

9. The method of claim 1, wherein the control device has at least two sub-control devices which each independently determine the reliability information for the automation system as a whole.

10. The method of claim 9, wherein the at least two sub-control devices are configured to be diversified.
